(19) United States
(12) Patent Application Publication
(10) Pub. No.: US 2011/0299670 A1
(43) Pub. Date: Dec. 8, 2011

(54) METHOD AND SYSTEM FOR RECORDING PERSONALIZED DIGITAL MEDIA FILES

(76) Inventor: Tom Krause, Hamburg (DE)

(21) Appl. No.: 12/794,691

(22) Filed: Jun. 4, 2010

(51) Int. Cl. H04M 11/00

(52) U.S. Cl. 379/88.13

(57) ABSTRACT

A method for providing a personalized digital media file comprising the steps of: receiving an order for a personalized digital media file from a user in an order system; sending a personalization request from the order system to a telecommunication and recording device; using the telecommunication and recording device to record a personalization message; transmitting the personalization message from the telecommunication and recording device to the order system; combining the personalization message with a digital media file to make the personalized digital media file; and making the personalized digital media file accessible to the user.

### TECHNICAL FIELD

The present invention generally relates to providing personalized digital media files, and more particularly, to providing personalized audio and video messages based on a user request.

### BACKGROUND OF THE INVENTION

U.S. patent application Ser. No. 11/008,598 (Publication 2006/0123975) discloses systems and methods for creating personalized or tailored compositions. An artist who created the original audio may have spoken or sung a personalized message, and may have stored it in digital or analog format. On request the previously recorded personalized message may be combined with the original audio and made available to a fan. However, while the resulting message may appear to be personal, no audio was recorded specifically for the fan. U.S. patent Ser. No. 11/008,598 is hereby incorporated by reference thereto in its entirety.

Similarly, U.S. patent application Ser. No. 12/116,281 (Publication 2009/0281794) provides a method for providing a gift with a personalized celebrity message. The method utilized pre-recorded audio celebrity messages, which can be combined with personal recordings. U.S. patent application Ser. No. 12/116,281 is hereby incorporated by reference thereto in its entirety.

Similarly, U.S. patent application Ser. No. 11/125,658 (Publication 2007/0003918) provides a method for matching a child's name with digital media in order to modify the digital media. The modified digital media is considered personalized to the child's name. U.S. patent application Ser. No. 11/125,658 is hereby incorporated by reference thereto in its entirety.

Similarly, U.S. patent application Ser. No. 11/530,750 (Publication 2007/0028264), which is a continuation of U.S. Pat. No. 7,123,696, provides a method of obtaining and merging an insert clip into a master clip. The modified master clip may use any voice including the originator's voice, celebrity voices, or the voices of celebrity impersonators. An element which allows a playback device to be identified enables Ser. No. 11/530,750 to differentiate from U.S. Pat. No. 7,123,696. U.S. patent application Ser. No. 11/530,750 is hereby incorporated by reference thereto in its entirety.

Similarly, U.S. Pat. No. 7,123,696 provides a method of obtaining and merging an insert clip into a master clip. The modified master clip may use any voice including the originator's voice, celebrity voices, or the voices of celebrity impersonators. U.S. Pat. No. 7,123,696 is hereby incorporated by reference thereto in its entirety.

Similarly, U.S. patent application Ser. No. 11/796,052 (Publication 2007/0233744) provides a method of producing a personalized data file by digitally combining a first data file with a prexisting data file. U.S. patent application Ser. No. 11/796,052 is hereby incorporated by reference thereto in its entirety.

### SUMMARY OF THE INVENTION

The present invention provides a method to allow artists and celebrities, herein used interchangeably, to record personalization messages on request and provide personalized media files to users. According to one aspect of the invention, a user can order a personalized version of a digital media file. This may for example be a song including a short personal introduction by the artist. Another example of a personalized version of a digital media file is a personalized ringtone. During the order process the user requests a personalization message and may provide specific personalization requests, e.g. “please dedicate this song to Paula from New York who turns 30 on Saturday, May 30th.”

Subsequently a personalization request including the specific request information is sent to the artist's handheld telecommunication and recording device. The handheld telecommunication and recording device may, for example, be a cellular telephone capable of running custom application programs (“apps”). The artist, responsive to the personalization request, records a personal message using the handheld telecommunication and recording device. The personal message is subsequently transmitted from the handheld telecommunication and recording device to the order system. The order system combines the personal message with the digital media file and makes the combined file available to the user.

During the order process the user can select a “mood” setting with which the celebrity is asked to speak the personal message. A mood request may for example be “happy” if the message is meant to be spoken with a happy voice. This allows a user to not only control the textual content of a message, but the sound of it.

An artist or celebrity can select which kinds of messages he or she doesn't want to speak and therefore can't be ordered. During the order process a user is presented with information regarding unacceptable texts, which may for example include certain offensive language, political opinions, religious believes etc. that the artist or celebrity doesn't want to be associated with. If a request is send to the artist or celebrity that is inconsistent with the artist's or celebrity's acceptance rules the artist or celebrity can flag the request as unacceptable and reject it. The artist's handheld device provides a user interface for flagging such requests. A request that has been flagged is sent back to the user for review and modification to comply with the artist's acceptable message criteria.

Artist may also specify, in which of one or more languages they accept personalization requests and will record personalization messages.

Personalization messages may be recorded on the handheld device and temporarily kept in an outbox on the mobile device, e.g. until a coverage area with faster network access such as a Wifi network can be established. This is particularly important if the artist/celebrity wants to record personalization messages while out of reach, e.g. while traveling on an airplane. Messages in the outbox may be buffered until a network connection can be established.

Personalization requests can be personal messages, or commercial requests, which use the celebrity message for economic gain.

The order system is designed to accept coupon codes, allowing e.g. a radio station to pre-purchase a larger number of personalization messages and convey the rights to one personalization message to several listeners. The user interface on the handheld device may include an indication of requests that are part of a coupon campaign. The user interface may further provide an indication, based on information received from the order system, if a request is a personal message or a commercial request.

Data is communicated between the server and the handheld device using http or https protocols and TCP/IP. The system is transparent to the physical layer of the mobile network (UMTS, 3G, 4G, etc.). The handheld device may communicate through any kind of internet connection, which may be the cellular data network or an 802.11 wireless connection.

Personalization messages are recorded in a suitable audio or video format, e.g. as PCM data, MP3, or MP4. Depending on the capability of the handheld device personalization messages may be recorded in raw format and later compressed into a suitable compressed data format or compressed in real time during recording. If data is compressed after recording the compression may take place on the server or the handheld device. Compression on the handheld device is preferable to reduce bandwidth. The compressed personalization message is combined with other audio (or video) content on the server, ultimately leading to an MP3 or AAC audio file or an MP4 video file. Any other digital audio and video format may be used.

The following detailed description of the invention is merely exemplary in nature and is not intended to limit the invention or the application and uses of the invention. Furthermore, there is no intention to be bound by any theory presented in the preceding background of the invention or the following detailed description of the invention.

### BRIEF DESCRIPTION OF THE DRAWINGS

FIG. 1 is a block diagram showing an embodiment of the present method.

FIG. 2 is a block diagram showing an embodiment of the method from the perspective of an artist or celebrity.

FIG. 3 is a block diagram showing an embodiment of the method from the perspective of an order system designed to employ the method.

FIG. 4 is a block diagram showing an embodiment of the method from the perspective of a user.

FIG. 5 is a block diagram of a typical computer system used for implementing embodiments of the present disclosure.

### DETAILED DESCRIPTION

The prior art cited in the background of the present disclosure describes methods used to prepare personalized compositions. However, the described methods don't enable the customized features that many users want when creating personalized compositions. One example of a customized feature is an ability to request an artist's mood when the artist creates the personalized composition. Hence, there exists a need for a method which enables customized features for personalized compositions. The present disclosure addresses that need and fulfills it.

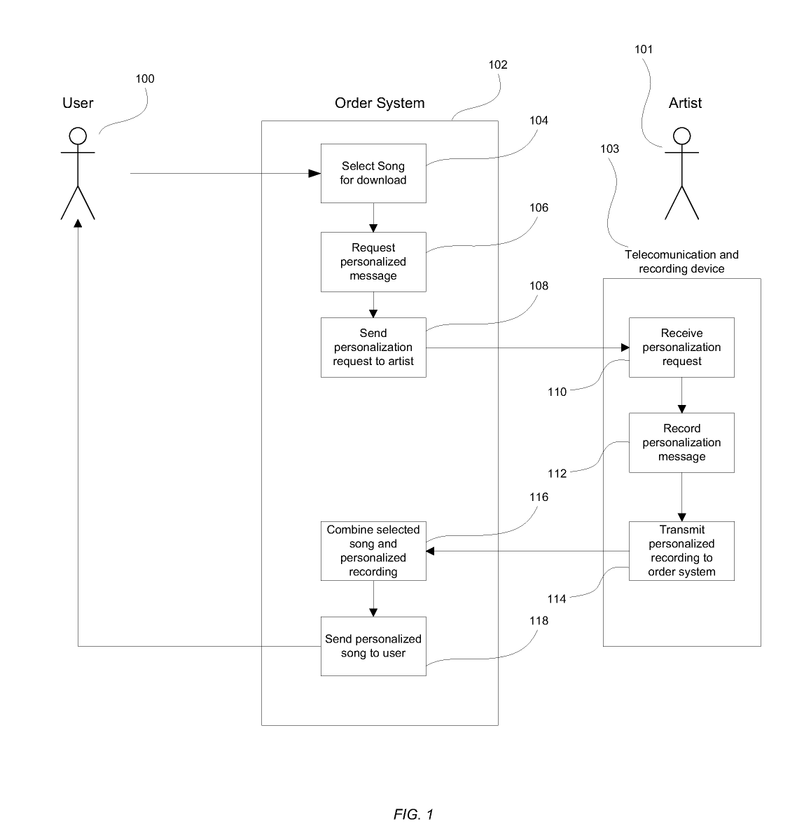

FIG. 1 is a block diagram showing an embodiment of the present method. The diagram shows an overview of the present method and shows how data is coordinated among a user 100, order system 102, and an artist 101, the artist having a telecommunication and recording device 103.

The first step 104 of FIG. 1 shows the user 100 accessing the order system 102 and selecting a song for download. The user 100 can access the system 102 with any device capable of using the internet such as a mobile phone, computer, or the like.

In step 106 the user 100 requests a personalized message from the order system. The personalized message can be a unique user specified message or a message chosen from a pre-existing group of messages. An exemplary personalization request might be for an artist to speak a dedication for the song that was ordered in step 104, such as “this song is dedicated to Paula from New York who turns 30 on Saturday, May 30th.” The personalization request may comprise one or more attributes, which can be selected by the user, and which may be selected from a predetermined set of possible entries that is unique to each artist. One exemplary attribute is a “mood” setting, in which the artist should speak the personalized message. Another attribute may be the language, in which the personalization message should be recorded.

In step 108 the personalization request is sent from the order system 102 to a telecommunication and recording device 103 of artist 101.

In step 110, the artist 101 receives the personalization request via a telecommunication and recording device 103. Steps 108 and 110 may utilize a push, or a pull communication scheme. In a push communication scheme order system 102 initiates the sending of a personalization request in step 108, and the telecommunication and recording device 103 responds to the push. In a pull communication scheme telecommunication and recording device 103 initiates the communication with order system 102 and requests new personalization request to be sent.

In step 112, the artist 101 records a personalization message which matches the personalization request.

In step 114, the artist 101 transmits the recorded personalization message to the order system 102.

In step 116, the order system 102 combines the selected song and recorded personalization message into a personalized recording, which is effectively a personalized song.

Finally, in step 118, the order system 102 sends the personalized song to the user 100. Step 118 may comprise sending an email to the user, the email comprising a hyperlink to a webserver, at which the personalized song is available for download.

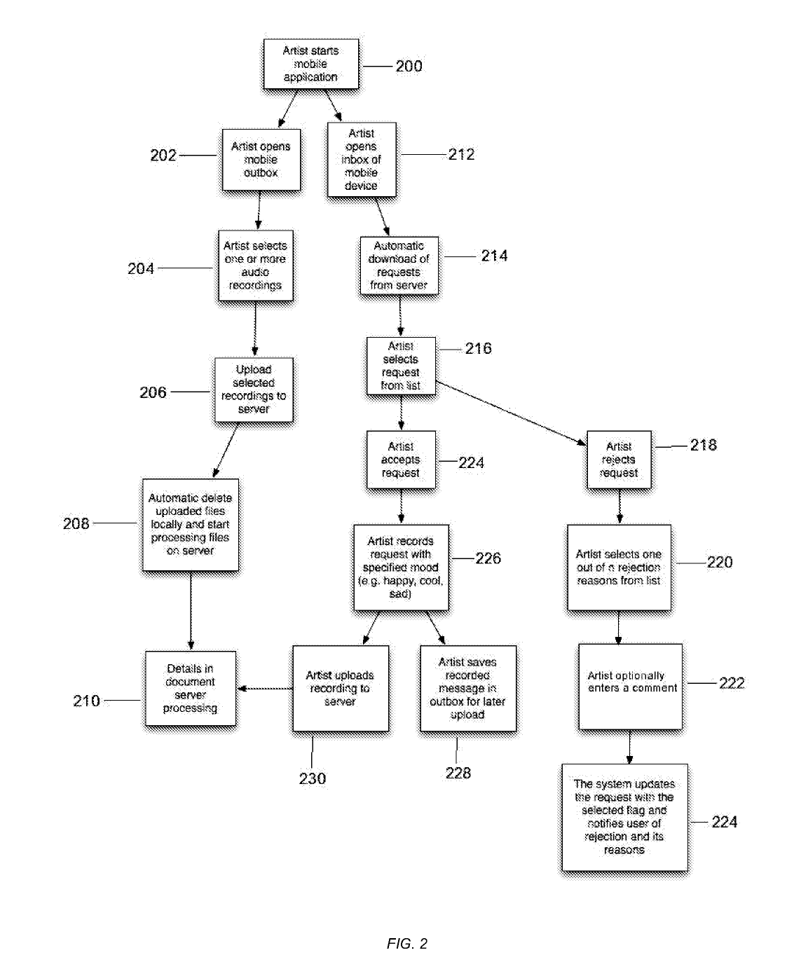

FIG. 2 is a block diagram showing an embodiment of the method from the perspective of an artist.

In the first step 200 of FIG. 2, the artist starts a mobile application which enables the artist to interface with the order system. In step 200 the artist first selects, whether to enter an outbox of previously recorded but not yet uploaded personalized messages (transition to step 202) or an inbox of personalization requests (transition to step 212).

In step 202, the artist opens a mobile outbox. The mobile outbox can contain digital messages and files which can be viewed, heard, or both viewed and heard. In this embodiment the digital messages and files are pre-existing audio recordings.

In step 204, the artist selects one or more pre-existing audio recordings.

In step 206, the artist uploads the pre-existing audio recordings to a server. The server is part of the order system.

In step 208, the mobile outbox automatically deletes the uploaded audio recordings and the server begins processing the uploaded audio recordings.

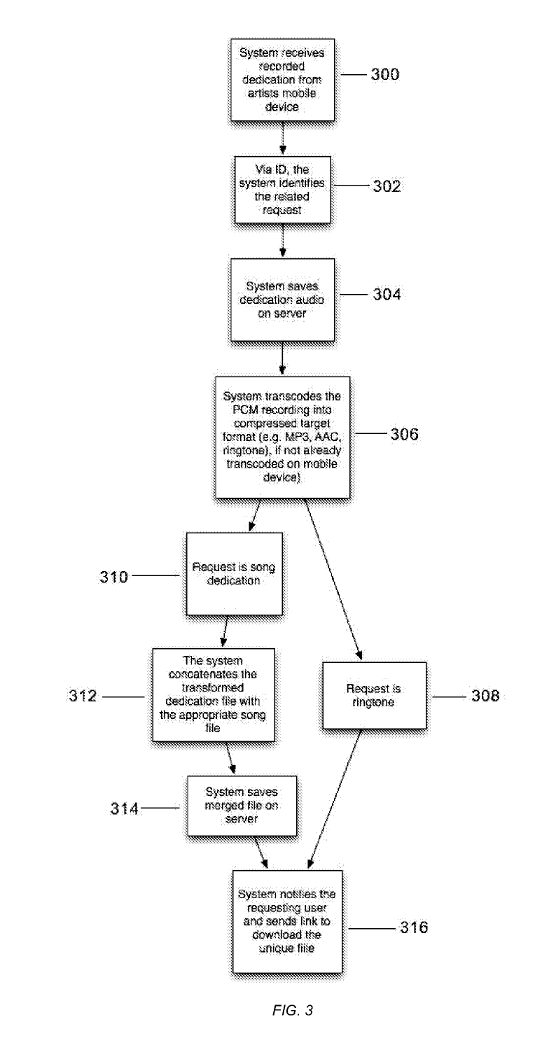

In step 210, further details of the method, which are executed within the order system, are given in FIG. 3.

In step 212, the artist opens the inbox of a mobile device. In a separate embodiment, the artist can open the inbox of a computer which is enabled to read messages. That is, the inbox does not necessarily have to reside on a mobile device.

In step 214, the artist automatically downloads a list of requests from the server, which is part of the order system.

In step 216, the artist selects a request from the list. Then, the artist can either accept the request, step 224, or reject the request, step 218. If the artist rejects the request, step 218, the artist selects a rejection reason from a pre-existing plurality of rejection reasons, step 220. The artist may optionally in step 222 enter a comment to provide additional information regarding the rejection and for example propose an acceptable alternative text. The rejection and rejection reason are communicated to the server of the order system and the order system updates the original user request with the artist's information, notifying the user of the rejection and rejection reason, step 224.

If the artist accepts the request, step 224, the artist records a request response with a specified mood such as happy, cool, sad, and the like, step 226. The artist can then either save the recorded request response in an outbox of the mobile device for later upload, step 228, or immediately upload the recorded request response to the server of the order system, step 230. In step 210, further details of the method, which are executed within the order system, are given in FIG. 3.

FIG. 3 is a block diagram showing an embodiment of the method from the perspective of an order system designed to employ the method. The order system can comprise a computing environment such as a computer server with supporting equipment.

In the first step 300 of FIG. 3, the order system receives a recorded dedication from the artist's mobile device or the outbox of whatever communication device the artist is using.

In step 302, using an identifier, the order system identifies a request which is related to the recorded dedication.

In step 304, the order system saves the recorded dedication audio on a server which is part of the order system.

In step 306, the order system transcodes the recorded dedication from the received format to the desired target format. Examples of formats are MP3, AAC, ringtone, wma, and the like.

If the request is a ringtone, step 308, the order system notifies the requesting user and sends the requesting user a link to download the unique file, step 316.

If the request is a song dedication, step 310, the order system concatenates the transformed dedication file with the appropriate song file, step 312. Then, the order system saves the concatenated file on a server within the order system, step 314. Finally, the order system notifies the requesting user and sends the requesting user a link to download the unique file, step 316.

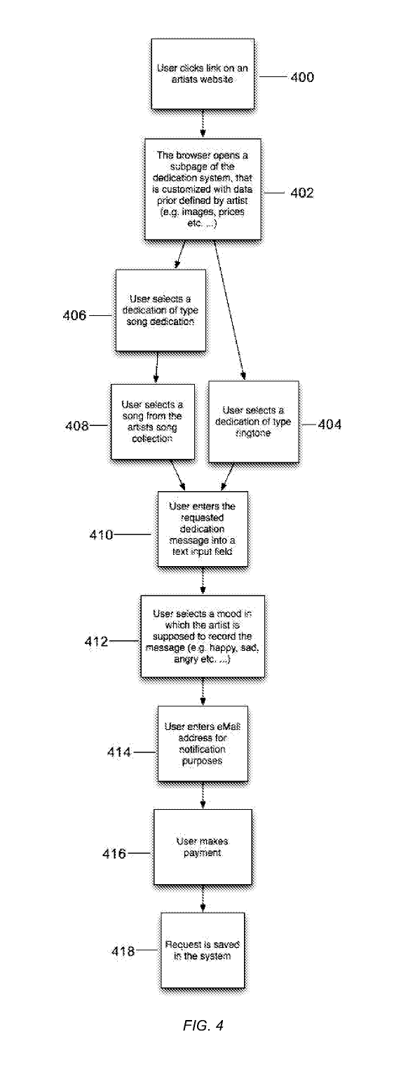

FIG. 4 is a block diagram showing an embodiment of the method from the perspective of a user.

In the first step 400 of FIG. 4, the user clicks a link on an artist's website. The website may include a link to a subpage to request personalized messages. The website may also comprise information, selected by the artist, to inform the user about acceptable personalization request. Such information may e.g. include a list of acceptable languages for the personalization request. It may also comprise information about messages that are unacceptable to the artist, e.g. because of offensive language, political opinions, religious believes or the like that the artist or celebrity doesn't want to be associated with.

In step 402 of FIG. 4, the user utilizes a web browser to open a web subpage of the order system. The web subpage is customized with prior data which the artist had defined. Examples of customized prior data are images, prices, and the like. The user then decides to either select a ringtone type of dedication, step 404 or a song type of dedication, step 406.

If the user selected the ringtone type of dedication, step 404, the user enters the requested dedication into a text input field, step 410.

If the user selected a song the song type of dedication, step 406, the user selects a song from the artist's song collection, step 408. Then, the user enters the requested dedication into a text input field, step 410.

In step 412, the user selects a mood in which the artist is supposed to record the message. Examples of moods are happy, sad, angry, and the like.

In step 414, the user enters an e-mail address for notification purposes. Step 414 may also allow entering two or more email addresses, e.g. to automatically send a notification e-mail to a third party.

In step 416, the user makes a payment. Payment can be made electronically such as with a credit card, bank debit, Paypal, or the like.

In step 418, the user request is saved in the order system. The order system can then execute the user request.

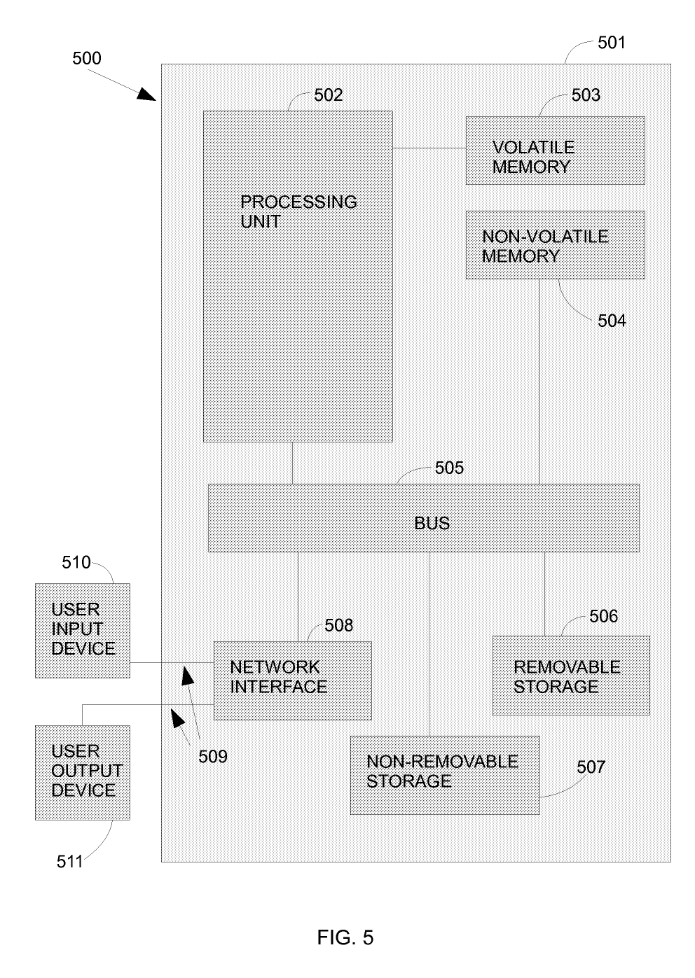

FIG. 5 is a block diagram of a typical computing environment used for implementing embodiments of the present disclosure. FIG. 5 and the following discussion are intended to provide a brief, general description of a suitable computing environment in which certain embodiments of the present disclosure may be implemented.

FIG. 5 shows a computing environment 500, which can include but is not limited to, a housing 501, processing unit 502, volatile memory 503, non-volatile memory 504, a bus 505, removable storage 506, non-removable storage 507, a network interface 508, ports 509, a user input device 510, and a user output device 511.

The environment can be implemented in a master/slave (server/client) or a peer-to-peer configuration.

Various embodiments of the present subject matter can be implemented in software, which may be run in the environment shown in FIG. 5 or in any other suitable computing environment. The embodiments of the present subject matter are operable in a number of general-purpose or special-purpose computing environments. Some computing environments include personal computers, server computers, hand-held devices (including, but not limited to, telephones and personal digital assistants (PDAs) of all types), laptop devices, multi-processors, microprocessors, set-top boxes, programmable consumer electronics, network computers, minicomputers, mainframe computers, distributed computing environments, and the like to execute code stored on a computer readable medium. The embodiments of the present subject matter may be implemented in part or in whole as machine-executable instructions, such as program modules that are executed by a computer. Generally, program modules include routines, programs, objects, components, data structures, and the like to perform particular tasks or to implement particular abstract data types. In a distributed computing environment, program modules may be located in local or remote storage devices.

A computer may include or have access to a computing environment that includes one or more user input modules, one or more user output modules, and one or more communication connections such as a network interface card or a USB connection. The one or more output devices can be a display device of a computer, computer monitor, TV screen, plasma display, LCD display, display on a digitizer, display on an electronic tablet, and the like. The computer may operate in a networked environment using the communication connection to connect one or more remote computers. A remote computer may include a personal computer, server, router, network PC, a peer device or other network node, and/or the like. The communication connection may include a Local Area Network (LAN), a Wide Area Network (WAN), and/or other networks.

Memory may include volatile memory and non-volatile memory. A variety of computer-readable media may be stored in and accessed from the memory elements of a computer, such as volatile memory and non-volatile memory, removable storage and non-removable storage. Computer memory elements can include any suitable memory device(s) for storing data and machine-readable instructions, such as read only memory (ROM), random access memory (RAM), erasable programmable read only memory (EPROM), electrically erasable programmable read only memory (EEPROM), hard drive, removable media drive for handling compact disks (CDs), digital video disks (DVDs), diskettes, magnetic tape cartridges, memory cards, memory sticks, and the like. Memory elements may also include chemical storage, biological storage, and other types of data storage.

“Processor” or “processing unit” as used herein, means any type of computational circuit, such as, but not limited to, a microprocessor, a microcontroller, a complex instruction set computing (CISC) microprocessor, a reduced instruction set computing (RISC) microprocessor, a very long instruction word (VLIW) microprocessor, an explicitly parallel instruction computing (EPIC) microprocessor, a graphics processor, a digital signal processor, or any other type of processor or processing circuit. The term also includes embedded controllers, such as generic or programmable logic devices or arrays, application specific integrated circuits, single-chip computers, smart cards, and the like.

Embodiments of the present subject matter may be implemented in conjunction with program modules, including functions, procedures, data structures, application programs, etc. for performing tasks, or defining abstract data types or low-level hardware contexts.

For the purposes of this disclosure, a system for producing a personalized digital media file comprises a user, order system, and an artist. The relationship between the user, order system, and artist is defined in FIG. 1 and within this disclosure.

For the purposes of this disclosure, a system for producing a personalized digital media file can also comprise: means for receiving an order for a personalized digital media file from a user in an order system; means for sending a personalization request from the order system to a telecommunication and recording device; means for using the telecommunication and recording device to record a personalization message; means for transmitting the personalization message from the telecommunication and recording device to the order system; means for combining the personalization message with a digital media file to make the personalized digital media file; and means for making the personalized digital media file accessible to the user.

Means for receiving an order for a personalized digital media file from a user in an order system is any telecommunication means available. An example is an internet capable server which receives an order via the internet.

Means for sending a personalization request from the order system to a telecommunication and recording device is any telecommunication means available. An example is an internet capable server which sends an order via the internet or a wireless phone network.

Means for using the telecommunication and recording device to record a personalization message is the ability of an artist to record with a computer, laptop, cellphone, handheld device, or the like.

Means for transmitting the personalization message from the telecommunication and recording device to the order system is the ability to use the internet, a wireless cellphone network, or the like.

Means for combining the personalization message with a digital media file to make the personalized digital media file is the ability to use a server, or the like, to combine digital files.

Means for making the personalized digital media file accessible to the user is the ability to send the personalized digital media file to the user via the internet, a wireless cellphone network, or the like.

While the present invention has been described with reference to exemplary embodiments, it will be readily apparent to those skilled in the art that the invention is not limited to the disclosed or illustrated embodiments but, on the contrary, is intended to cover numerous other modifications, substitutions, variations and broad equivalent arrangements that are included within the spirit and scope of the following claims.

What is claimed is:

1. A method for providing a personalized digital audio or video media file comprising the steps of:
a) receiving an order for a personalized digital media file from a user in an order system;
b) sending a personalization request from the order system to a telecommunication and recording device;
c) using the telecommunication and recording device to record a personalization message;
d) transmitting the personalization message from the telecommunication and recording device to the order system;
e) combining the personalization message with a digital media file to make the personalized digital media file; and
f) making the personalized digital media file accessible to the user.

2. The method of claim 1, further comprising the steps of:
providing the user information about acceptable content of the personalization requests and
providing an option on the telecommunication and recording device to reject a personalization request for non-compliance with the information about acceptable content provided to the user.

3. The method of claim 2, wherein the information about acceptable content provided to the user comprises a list of languages.

4. The method as in claim 1, further comprising the steps of
entering a coupon code into the order system and
providing a user interface on the telecommunication and recording device to associate a personalization request with a coupon code.

5. The method of claim 1, wherein the order system comprises a server with telecommunication means.

6. The method of claim 1, wherein the personalization request comprises a request to record the personalization message in a specified mood.

7. The method of claim 1, wherein the digital media file comprises a song or a video performed by an artist.

8. The method of claim 1, wherein the telecommunication and recording device comprises a cellular phone, personal digital assistant, smart phone, or computer.

9. The method of claim 1, wherein the personalization request comprises a ringtone which incorporates a mood.

10. The method of claim 1, wherein the personalization request comprises a song which incorporates a mood.

11. A system for producing a personalized digital media file, the system comprising:
a) means for receiving an order for a personalized digital media file from a user in an order system;
b) means for sending a personalization request from the order system to a telecommunication and recording device;
c) means for using the telecommunication and recording device to record a personalization message;
d) means for transmitting the personalization message from the telecommunication and recording device to the order system;
e) means for combining the personalization message with a digital media file to make the personalized digital media file; and
f) means for making the personalized digital media file accessible to the user.

9. The system of claim 11, wherein the order system comprises a server with telecommunication means.

10. The system of claim 11, wherein the personalization request comprises an audio message which incorporates a mood.

11. The system of claim 11, wherein the digital media file comprises a song performed by an artist.

12. The system of claim 11, wherein the telecommunication and recording device comprises a cellular phone, personal digital assistant, smart phone, or computer.

13. The system of claim 11, wherein the personalization request comprises a ringtone which incorporates a mood.

14. The system of claim 11, wherein the personalization request comprises a song which incorporates a mood.
